(19) United States
(12) Patent Application Publication
(10) Pub. No.: US 2026/0178320 A1
(43) Pub. Date: Jun. 25, 2026

(54) Streaming Protocol to Support Read-Only Memory (ROM) Patching

(71) Applicant: Google LLC, Mountain View, CA (US)

(72) Inventors: Harsharaj Ellur, Bangalore (IN); Afshin Hosseinipour, San Diego, CA (US); Kyle John Rupnow, Wheeling, IL (US)

(73) Assignee: Google LLC, Mountain View, CA (US)

(21) Appl. No.: 19/535,753

(22) Filed: Feb. 10, 2026

Related U.S. Application Data
(60) Provisional application No. 63/978,838, filed on Feb. 9, 2026.

(51) Int. Cl. G06F 8/65

(52) U.S. Cl. CPC G06F 8/66

(57) ABSTRACT

Fixed patching protocols waste memory resources and increase boot-up latency. In contrast, example implementations include a patch controller that receives a stream of multiple patch units from a non-volatile patch memory. The patch controller parses a descriptor patch unit, which precedes a set of patch units in the stream. From the descriptor patch unit, the patch controller extracts a ROM-patch type and a count. The type indicates whether the succeeding set of patch units includes fully associative patch units, direct-mapped patch units, or a combination. The count indicates the quantity of patch units of each type following the descriptor. Based on the extracted type and count, the patch controller processes the stream by routing the patch units to a fully associative memory or a direct-mapped memory. This streaming protocol enables flexible allocation of patch resources, reduces storage overhead in non-volatile memory, and shortens boot-up time by supporting an end-of-stream marker.

### CROSS-REFERENCE TO RELATED APPLICATION

This application claims the benefit of U.S. Provisional Patent Application No. 63/978,838 filed on 9 Feb. 2026, the disclosure of which is incorporated by reference herein in its entirety.

### BACKGROUND

Computing and other electronic devices play integral roles in manufacturing, communication, transportation, healthcare, commerce, social interaction, entertainment, and other services. For example, electronic devices power the server farms that provide cloud-based, distributed computing functionality for commerce, communication, and large-model or high-demand artificial intelligence (AI) technologies. Electronic devices are also embedded in many different types of modern equipment, from medical devices to appliances and from vehicles to industrial tools. Personal electronic devices enable portable video viewing, convenient smart digital assistants, and access to local and remote AI services. Additionally, one versatile electronic device—the smartphone—has practically become a necessity to have within arm's reach.

To initialize, or boot, an electronic device, a processor accesses information that is stored in a read-only memory (ROM). This information can include, for example, instructions that are executed and data that is useful to “jumpstart” operation of the electronic device. This initial information is often also pertinent to establishing a secure computing environment. As such, the ROM information is typically treated with the utmost care. Nonetheless, the ROM information often still needs to be updated after the initial circuitry plan for an integrated circuit is finalized. ROM information updating entails incorporating a ROM patch into the initialization process. Unfortunately, implementing a ROM patch in an efficient manner is challenging.

### SUMMARY

Some read-only memory (ROM) patching systems rely on rigid, predefined configurations that fix the ratio of patch types at the time of initial programming, leading to inefficient use of non-volatile storage. These systems frequently require streaming a complete, fixed-size memory partition during boot-up, which introduces unnecessary latency and complicates error-correction-code (ECC) alignment for incremental ROM updates.

In contrast, this document describes hardware and techniques that support ROM patching using a descriptor-driven streaming protocol. In some implementations, a patch controller enables a lower allocation of hardware resources by parsing metadata from a patch stream. This metadata can be provided by a descriptor patch unit that specifies a ROM-patch type and a corresponding quantity of patch units per ROM-patch type. Based on this information, the patch controller can dynamically route incoming data to different memory structures, like a fully associative memory or a direct-mapped memory.

The use of a descriptor-based protocol allows a manufacturing paradigm to adjust the distribution of patch resources for each ROM update. This can optimize the utilization of expensive one-time programmable (OTP) memory on a silicon die, like a system-on-chip (SoC). By eliminating fixed partitions, the system achieves at least two benefits. First, different patch types can be interleaved as appropriate without squandering non-volatile storage space. Second, each new ROM update can occupy an amount of non-volatile storage space that matches the amount of ROM content changes. This also reduces a total size of the “final” ROM patch.

Certain implementations can also include control indicators within the ROM patch stream to improve operational performance. For example, an end-of-stream marker can signal a ROM controller to terminate a ROM-stream transfer once all patches are received and before the entirety of the contents of a non-volatile patch memory has been transferred, thereby reducing boot-up latency. Additionally or alternatively, the ROM patching protocol can support padding patch units that facilitate aligning patch data with specific boundaries for error code purposes, such as eight-byte boundaries. This alignment ensures that error code data (e.g., parity or ECC data) can be computed and programmed for individual patches or incremental updates. This can simplify fabrication, testing, and inventory management flows during manufacturing.

In example implementations, an apparatus for supporting read-only memory (ROM) patching is described. The apparatus includes a fully associative memory, a direct-mapped memory, and a patch controller that is coupled to the fully associative memory and the direct-mapped memory. The patch controller is configured to receive a stream including multiple patch units and to parse a patch unit from the stream. Here, the parsed patch unit precedes a set of patch units in the stream of the multiple patch units. The patch controller is also configured to extract from the parsed patch unit at least one type and at least one count. The at least one type is indicative of at least one ROM-patch type included in the set of patch units, and the at least one count is indicative of how many patch units of the at least one ROM-patch type follow the parsed patch unit in the set of patch units. The patch controller is further configured to process the stream of the multiple patch units by routing one or more patch units of the set of patch units to the fully associative memory or the direct-mapped memory based on the at least one type and the at least one count.

In example implementations, a method for supporting ROM patching is described. The method includes receiving, at a patch controller, a stream including multiple patch units. The method also includes parsing a patch unit from the stream of the multiple patch units, with the parsed patch unit preceding a set of patch units in the stream. The method additionally includes extracting from the parsed patch unit at least one type and at least one count. The at least one type is indicative of at least one ROM-patch type included in the set of patch units, and the at least one count is indicative of how many patch units of the at least one ROM-patch type follow the parsed patch unit in the set of patch units. The method further includes processing the stream of the multiple patch units by routing one or more patch units of the set of patch units to a fully associative memory or a direct-mapped memory based on the at least one type and the at least one count. Other implementations are described herein.

### BRIEF DESCRIPTION OF DRAWINGS

Apparatuses of and techniques for supporting read-only memory (ROM) patching using a streaming protocol are described with reference to the following drawings. The same numbers are used throughout the drawings to reference like features and components.

FIG. 1 illustrates an example apparatus with a ROM, a ROM controller, and a non-volatile patch memory (NPM) that can implement a streaming protocol to support ROM patching.

FIG. 2 is a block diagram illustrating an example ROM architecture that can implement a streaming protocol to support ROM patching.

FIG. 3-1 is a diagram illustrating example data structures for multiple types of patch units, including a descriptor patch unit, a fully associative patch unit, and a direct-mapped patch unit.

FIG. 3-2 is a diagram of an example ROM patch stream organized into multiple patch unit streams that are demarcated by descriptor patch units.

FIG. 4 depicts example patch unit streams that each include at least one descriptor patch unit indicative of a patch type for the patch unit stream in accordance with a streaming protocol to support ROM patching.

FIG. 5-1 is a schematic diagram illustrating example techniques for loading a ROM patch from a non-volatile patch memory in accordance with a streaming protocol to support ROM patching.

FIG. 5-2 is a schematic diagram illustrating example techniques for providing ROM content and ROM patch content to a processor during boot time in accordance with a streaming protocol to support ROM patching.

FIG. 6-1 is a flow chart illustrating example techniques for loading a ROM patch from a non-volatile patch memory in accordance with a streaming protocol to support ROM patching.

FIG. 6-2 is a flow chart illustrating example techniques for providing ROM content and ROM patch content to a processor during boot time in accordance with a streaming protocol to support ROM patching.

FIG. 7 is a flow diagram illustrating example processes for supporting ROM patching using a streaming protocol.

FIG. 8 illustrates various components of an example electronic device that can implement a streaming protocol to support ROM patching in accordance with one or more described aspects.

### DETAILED DESCRIPTION

### Overview

Electronic devices provide features and perform functions to make important contributions to modern society, such as those related to communication, safety, manufacturing, content creation, and information technology generally. These contributions depend on the electronic device being able to properly start up, which is referred to as initialization or booting. To enable this initialization, an electronic device includes a read-only memory (ROM) that stores initial code or data used during the boot process. Due to the complex nature of integrated circuit (IC) design and coding interactions, errors or vulnerabilities may be identified in the ROM content after an IC chip has been designed, manufactured, or deployed. To address such errors or vulnerabilities, ROM patching mechanisms allow for the replacement of original ROM content and the inclusion of new ROM information during booting. This document describes techniques to support ROM patching using a flexible streaming protocol.

In some ROM-patching architectures, two types of patch structures are utilized: fully associative (FA) patches and direct-mapped (DM) patches. Fully associative patches are generally used for inline instruction replacement and are stored in fully associative memory, like a content-addressable memory (CAM). Direct-mapped patches are typically used to add larger blocks of code or data and are stored in a direct-mapped memory, like a static random-access memory (SRAM). During a boot sequence, a ROM controller retrieves these patches from a non-volatile “patch” memory, like a set of one-time programmable (OTP) fuses, and loads them into the respective fully associative or direct-mapped memory.

In one approach to ROM-patching data structures, a rigid, predefined configuration is relied on that is established during the initial programming of the non-volatile patch memory. For instance, a fixed partition size and a predetermined ratio of fully associative patches to direct-mapped patches may be set at the time a first patch is added. This lack of flexibility prevents the efficient use of the limited and expensive non-volatile storage space for subsequent incremental patches because the system cannot dynamically adapt to varying quantities or sizes of future fully associative or direct-mapped patch additions. Furthermore, such rigid structures often necessitate the use of significant padding bytes to maintain specific, predefined data alignments, which leads to still more wasted storage in the non-volatile patch memory.

Operational challenges also exist regarding incorporating error-code protection, like error correction code (ECC) protection, with the ROM patches. In one approach for error-code protection, ECC is computed and programmed over a fixed granularity, such as eight bytes. If a patch size is not a multiple of this granularity, a single ECC block may span across two different patches. This inter-patch dependency can prevent the atomic ECC-value programming of individual patches. Thus, a manufacturing order involves waiting until an entire memory partition is finalized before ECC values can be calculated and blown into the fuses. This misalignment and consequential programing delay creates constraints that increase manufacturing complexity and hinder the ability to deploy independent incremental patches securely. For instance, a manufacturing facility may be fabricating and testing hundreds of thousands of IC chips that are at different stages of completion or have a different baseline ROM-boot code. Tracking these thousands of chips and their corresponding ROM status is a significant and costly logistical effort.

Additionally, the patch retrieval process may suffer from sub-optimal latency. In one approach, a system streams an entire fixed-size patch partition from the non-volatile patch memory to a patch controller, regardless of the actual number or size of valid patches that are stored in the non-volatile patch memory. This mechanism results in the transmission of unused or empty memory regions, which increases boot-up time and prevents the system from exiting a reset mode as quickly as could be possible. These deficiencies in flexibility, storage utilization, and streaming efficiency limit the effectiveness of ROM patching in modern electronic devices.

In contrast, this document describes hardware and techniques that support ROM patching using a streaming protocol. In some described approaches, a patch controller of a ROM controller receives a stream of multiple patch units from a non-volatile patch memory. The patch controller parses a descriptor patch unit from the stream, where the descriptor patch unit precedes a set of patch units. From the descriptor patch unit, the patch controller extracts at least one type and at least one count. The at least one type indicates a ROM-patch type included in the set of patch units, and the at least one count indicates how many patch units of that type follow the descriptor patch unit in the stream. Based on the extracted type and count, the patch controller processes the stream by routing patch units of the set of patch units to a fully associative memory or a direct-mapped memory.

By utilizing a descriptor-based streaming protocol, a manufacturing scheme can dynamically allocate hardware resources for different ROM patch types. For example, a single ROM patch stream can include any combination of fully associative patch units and direct-mapped patch units without requiring a pre-defined or fixed ratio of these units. This flexibility improves the utilization of the non-volatile patch memory, which may be formed from one-time programmable (OTP) fuses, by reducing reliance on pre-allocated storage regions or rigid data structures.

In some implementations, the streaming protocol supports control indicators that enhance the patching process. For instance, the patch controller can parse an end-of-stream marker from the stream. Upon detecting the end-of-stream marker, the patch controller can cease processing the stream and signal a boot controller or a processor that the ROM patching is complete. This allows the electronic device to exit a reset mode and begin a boot sequence as soon as all valid patches are loaded from the non-volatile patch memory, instead of waiting for an entire fixed-size memory partition to be transmitted, to thereby reduce boot-up latency.

Additionally, the protocol supports the use of padding patch units. These padding patch units can be used to align sets of patch units or incremental patches with specific boundaries (e.g., eight-byte boundaries) that match those utilized with a given error-code protocol. Such alignment ensures that error codes, like error correction code (ECC) data, can be computed and programmed atomically for each incremental patch. This reduces operational complexity in manufacturing flows by allowing individual patches to be protected and finalized independently. In short, the logistical nightmare of tracking the ROM status of hundreds of thousands of IC chips can be obviated using padding patch units in accordance with described implementations of a ROM patch streaming protocol.

Example method implementations for supporting ROM patching with a streaming protocol are also described. For example, a stream of multiple patch units is received at a patch controller, and the patch controller parses a descriptor patch unit from the stream. The method also includes extracting a ROM-patch type and a patch-unit count from the descriptor patch unit. Based on the type and count, the method includes processing the stream by routing patch units to a fully associative memory or a direct-mapped memory. Further implementations involve responding to control indicators like end-of-stream markers or padding bytes to manage the stream efficiently. These and other example implementations and operations are described herein.

### Example Environments and Electronic Devices

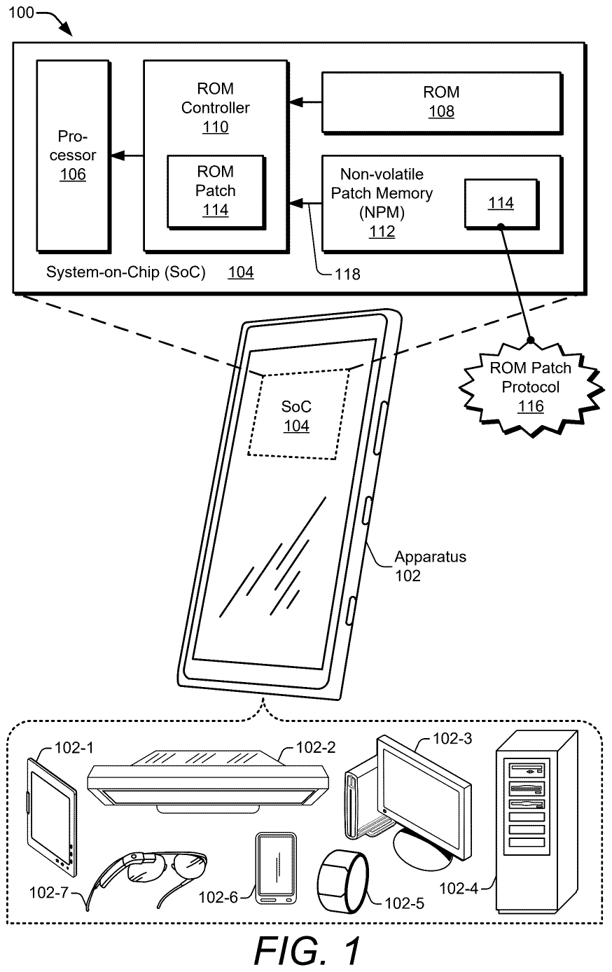

FIG. 1 illustrates, at 100 generally, an example apparatus with a ROM 108, a ROM controller 110, and a non-volatile patch memory 112 (NPM 112) that can implement a streaming protocol to support ROM patching. As shown, the apparatus 102 includes at least one system-on-chip 104 (SoC 104) or another integrated circuit (IC) chip. In example implementations, the SoC 104 includes at least one processor 106, at least one ROM 108, at least one ROM controller 110, and at least one non-volatile patch memory 112. The non-volatile patch memory 112 includes at least one ROM patch 114. The ROM patch 114 is formatted, organized, or otherwise configured in accordance with at least one ROM patch protocol 116.

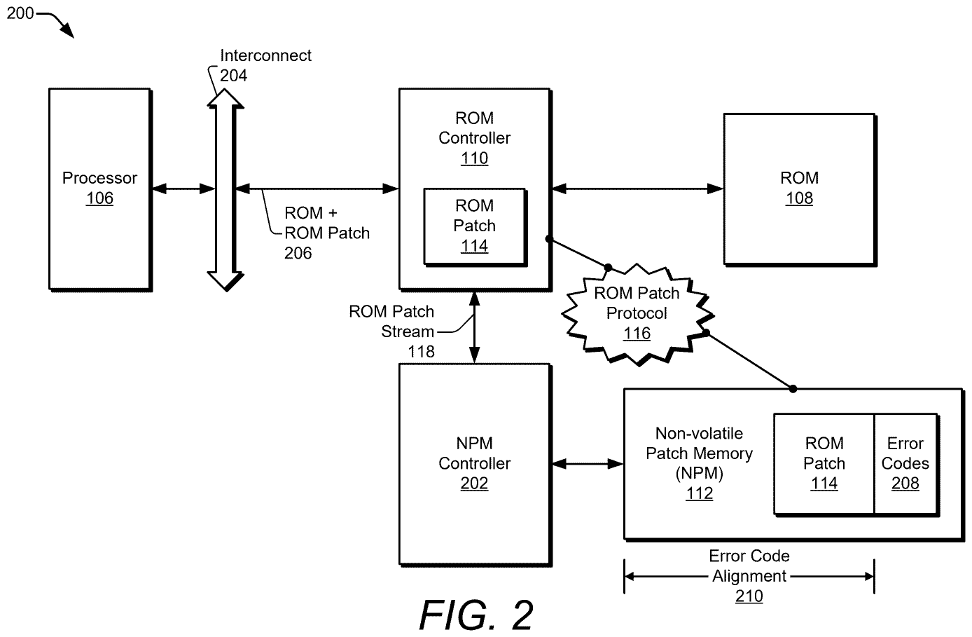

In example operations, the ROM controller 110 causes the non-volatile patch memory 112 to provide the ROM patch 114 as a ROM patch stream 118. This facilitates the ROM controller 110 having lower-latency access to the ROM patch 114 as well as the ROM 108. Examples of the ROM patch 114 and the ROM patch stream 118 are described herein. Example hardware and techniques to implement the ROM patch protocol 116 to support ROM patching are also described herein, including below with reference to the example ROM architecture of FIG. 2.

In the illustrated example of FIG. 1, the apparatus 102 is depicted as a smartphone. The apparatus 102 may, however, be implemented as any suitable computing or other electronic device as described herein. Examples of the apparatus 102 include a mobile electronic device or mobile device, mobile communication device, modem, cellular or mobile phone, mobile station, gaming device, navigation device, media or entertainment device (e.g., a media streamer or gaming controller), laptop computer, desktop computer, tablet computer, smart appliance, vehicle-based electronic system, wearable computing device (e.g., clothing, pin, watch, or reality-altering glasses), Internet of Things (IoTs) device, sensor, stock management device, electronic portion of a machine or piece of equipment (e.g., a vehicle or robot), memory storage device (e.g., a solid-state drive (SSD)), server computer or portion thereof (e.g., a server blade or rack or another part of a datacenter), and the like. Illustrated examples of the apparatus 102 include a tablet device 102-1, a smart television 102-2, a desktop computer 102-3, a server computer 102-4, a smartwatch 102-5, a smartphone (or document reader) 102-6, and intelligent glasses 102-7 (e.g., virtual or mixed reality glasses).

### Example Apparatuses and Operational Schemes

FIG. 2 is a block diagram illustrating an example ROM architecture 200 that can implement a streaming protocol to support ROM patching. The ROM architecture 200 establishes a high-level framework for how a processor 106 interacts with a ROM controller 110, a ROM 108, and a non-volatile patch memory 112 during an initialization or boot-up phase. As shown, the processor 106 is coupled to an interconnect 204, which provides a communication fabric to facilitate data transfers between the processor 106 and the ROM controller 110. The ROM controller 110 is further coupled to the ROM 108, which stores ROM content, like initial instructions or data. To support the updating or correction of the content within the ROM 108, the ROM controller 110 is also coupled to a non-volatile patch memory controller 202 (NPM controller 202), which manages access to the non-volatile patch memory 112.

In example implementations, the non-volatile patch memory 112 stores at least one ROM patch 114 and may include one or more components used to write or read the ROM patch 114 in accordance with a ROM patch protocol 116. In some cases, the non-volatile patch memory 112 also stores one or more error codes 208. The error codes provide integrity protection for the data stored within the non-volatile patch memory 112. The error codes 208 may be implemented using any error-detection or correction protocol, like one that uses at least one parity bit or one or more error-correction code (ECC) values.

The ROM patch information and the error codes 208 are organized within the non-volatile patch memory 112 to satisfy an error code alignment 210, such as an eight-byte boundary for some ECC protocols. During a reset or boot-up operation that utilizes the ROM patch 114, the non-volatile patch memory controller 202 retrieves information from the non-volatile patch memory 112 and provides a ROM patch stream 118 to the ROM controller 110. The ROM controller 110 processes the ROM patch stream 118 to internalize (e.g., organize and store) the ROM patch 114 in accordance with the ROM patch protocol 116 as described herein. After at least part of the ROM patch 114 is processed, the ROM controller 110 can provide a combination of ROM and ROM patch 206 content (e.g., ROM content from the ROM 108 and ROM patch content of the ROM patch 114 that is “now” stored at the ROM controller 110) to the processor 106 via the interconnect 204.

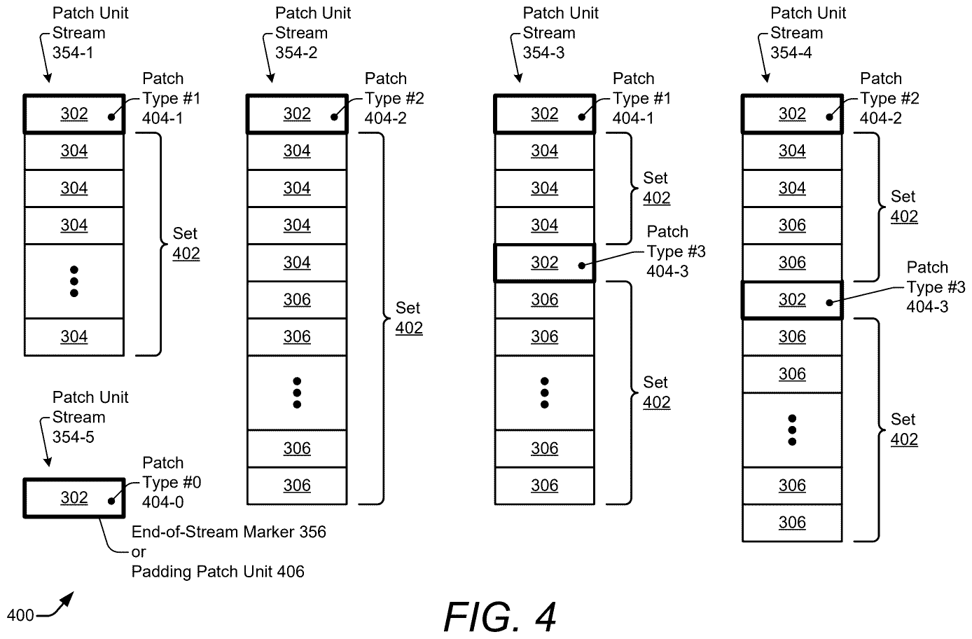

In example operations, the ROM controller 110 implements the ROM patch protocol 116 to transition the system from a reset mode to an active boot mode. Upon a reset or power-on event, the ROM controller 110 requests the ROM patch stream 118 from the non-volatile patch memory controller 202. The non-volatile patch memory controller 202 accesses the non-volatile patch memory 112 and transmits the ROM patch 114 as the ROM patch stream 118. The ROM patch stream 118 includes a series of patch units. Examples of patch units, patch types, and patch unit streams are described below with reference to FIGS. 3-1 and 3-2. Examples of different patch types are described further in relation to patch unit streams with reference to FIG. 4.

The architecture 200 provides several technical advantages by utilizing a descriptor-driven streaming protocol. By being configured to interpret the ROM patch stream 118, the ROM controller 110 enables dynamic allocation of hardware resources for fully associative and direct mapped patches based on the needs of each specific update. This flexibility enhances the utilization of the non-volatile patch memory 112 and can eliminate the need for rigid, predefined memory partitions. Further, the use of a streaming protocol enables the non-volatile patch memory controller 202 or the ROM controller 110 to signal the end of a ROM patch transmission “early.” In other words, the streamed transmission can be terminated prior to transferring the bit-information across the entirety of the non-volatile patch memory 112. This early termination can prevent the unnecessary transfer of unused memory regions. The reduction in data transfer directly lowers the boot-up latency of the electronic device 102, allowing the processor 106 to access the ROM and ROM patch 206 content more quickly after a reset.

Additionally, the ROM patch 114 can be organized based on the error code alignment 210. This enables the non-volatile patch memory controller 202 to store (e.g., blow for a fuse-based non-volatile patch memory 112) error codes 208 atomically with individual patch unit streams, or another patch-unit based construct. This arrangement reduces operational complexity in manufacturing by allowing each separate patch to be independently protected by at least one error code without requiring a full finalization of the entire patch memory region.

FIGS. 3-1 and 3-2 are diagrams 300-1 and 300-2, respectively, that describe patch unit data structures 352 and 354 and their organization within a ROM patch stream 118. More specifically, FIGS. 3-1 and 3-2 depict example parts, like different types of patch units 302-306 and patch unit streams 354, of an example streaming protocol that can support ROM patching.

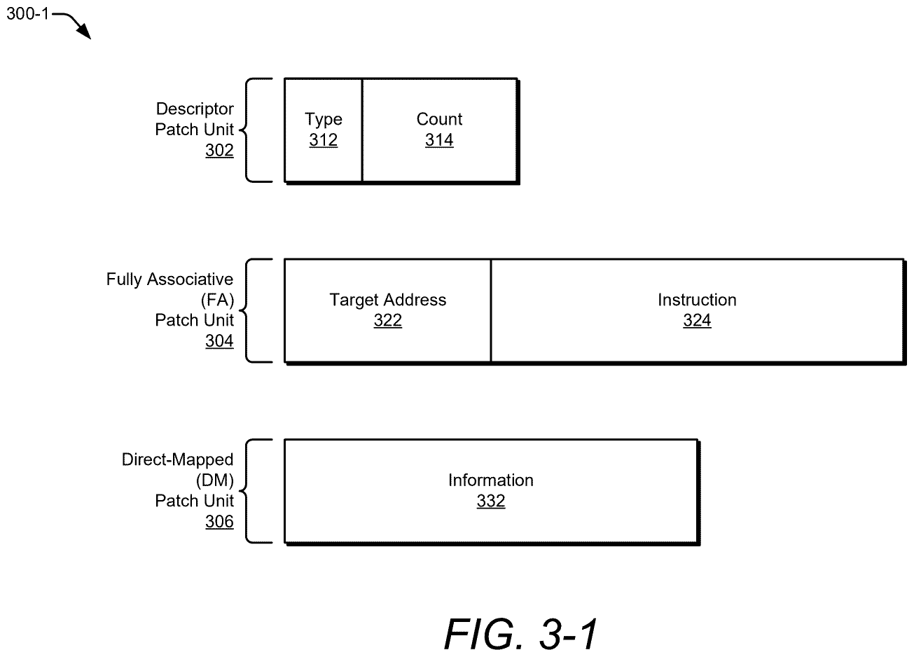

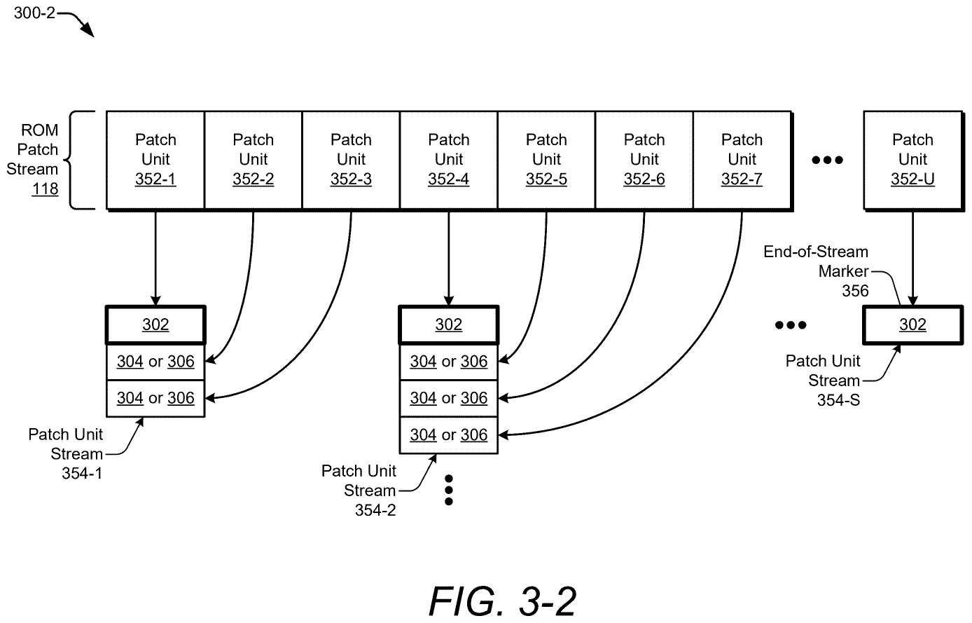

FIG. 3-1 illustrates multiple example types of patch units 302-306 that can form a ROM patch. In example implementations, these patch units include a descriptor patch unit 302, a fully associative patch unit 304, and a direct-mapped patch unit 306. The descriptor patch unit 302 acts as a header or metadata carrier that precedes a set of patch units that carry ROM information. The descriptor patch unit 302 can include two fields: at least one type 312 and at least one count 314. By way of example, the descriptor patch unit 302 may be realized with a single byte in which the type 312 and the count 314 are defined by specific bit-fields within that byte (e.g., fields of two bits and six bits, respectively).

The fully associative patch unit 304 (FA patch unit 304) is configured to provide an inline instruction replacement for a specific address in the ROM 108. The fully associative patch unit 304 includes at least one target address 322 and at least one corresponding instruction 324. For example, a fully associative patch unit 304 may be approximately six bytes in size, with two bytes allocated for the target address 322 and four bytes allocated for the instruction 324. In some cases, the fully associative patch unit 304 may be realized as a “functional address” patch unit 304. The instruction 324 may replace the instruction in the ROM 108 at the target address 322 in a one-to-one instruction-mapping situation. Alternatively, the instruction 324 may be a jump instruction that points to a location in a direct-mapped memory.

The direct-mapped patch unit 306 (DM patch unit 306) is configured to provide additional information (e.g., code or data) that can be mapped to a memory region outside of the original ROM address space. Thus, the direct-mapped patch unit 306 includes at least one field having information 332. By way of example, the information 332 may consume four bytes, like for a four-byte instruction or a four-byte data value. In some cases, the direct-mapped patch unit 306 may be realized as a “data modification” patch unit 306. As is described below with reference to FIGS. 5-1 and 5-2, a fully associative patch unit 304 may be stored in a fully associative memory, and a direct-mapped patch unit 306 may be stored in a direct-mapped memory. Next, however, this document describes an example ROM patch stream 118 that includes multiple patch units 352.

FIG. 3-2 illustrates an example ROM patch stream 118 that is organized into multiple patch unit streams 354-1, 354-2, through 354-S that are demarcated by respective descriptor patch units 302. As shown, the ROM patch stream 118 includes a sequence of multiple patch units 352-1, 352-2, 352-3, 352-4, 352-5, 352-6, 352-7, through 352-U, with “U” representing a positive integer. Each patch unit 352 can be realized with any patch unit data structure, like a descriptor patch unit 302, a fully associative patch unit 304, or a direct-mapped patch unit 306.

In example implementations, the multiple patch units 352-1 to 352-U are organized into “S” patch unit streams 354-1, 354-2, through 354-S, with “S” representing a positive integer. Each patch unit stream 354 is demarcated by a descriptor patch unit 302 that describes the set of patch units 352 that follow the descriptor patch unit 302. For example, the patch unit stream 354-1 includes a descriptor patch unit 302 followed by a set of data patch units 352 that number two, like a fully associative patch unit 304 or a direct-mapped patch unit 306. The patch unit stream 354-2 includes a descriptor patch unit 302 followed by a set of data patch units 352 having a quantity of at least three. As illustrated, the type(s) of patch units 352 (e.g., one or more fully associative patch units 304 or one or more direct-mapped patch units 306) that follow a descriptor patch unit 302 are indicated by the contents of the descriptor patch unit 302, as is described below.

A “final” patch unit stream 354-S includes a descriptor patch unit 302 that includes or represents an end-of-stream marker 356. The end-of-stream marker 356 signals a controller that the streaming process of the patching operation is complete. This controller can be, for example, a ROM controller 110, a non-volatile patch memory controller 202, a combination thereof, and so forth. Thus, as described further below, the ROM controller 110 or the non-volatile patch memory controller 202 may be configured to detect the end-of-stream marker 356 and terminate the transmission of the ROM patch stream 118.

In example operations for processing the ROM patch stream 118 in accordance with a streaming protocol, the patch-unit processing is driven, at least partly, by bit-field definitions within the descriptor patch unit 302. A patch controller of the ROM controller 110 parses the ROM patch stream 118 and extracts the type and count values to determine how to route the succeeding patch units. Table 1 below provides example field definitions for a one-byte descriptor patch unit 302:

TABLE 1
Examples of Descriptor Patch Unit 302 Field Definitions

| Type (T) | Count (C) [5:0] | |
|---|---|---|
| [1:0] | (6 bits) | Functional Use Case |
| (2 bits) | Definition Examples | Examples |
| 0x0 | Unused header; no associated | (1) End-of-stream signaling; |
| (Control) | units: | (2) Error-code boundary |
| | (1) C = 0x0: Marker; | alignment |
| | (2) C = 0x1: Padding patch | |
| | unit | |
| 0x1 | Quantity of fully associative | Inline code updates (e.g., |
| (Type-1) | patch units (≤64) | consecutivefully associative |
| | | patch units and excluding |
| | | direct-mapped units) |
| 0x2 | C[1:0]: fully associative | Combined patch unit stream |
| (Type-2) | count (≤4); | including two patch memory |
| | C[5:2]: direct-mapped | types (e.g., consecutive fully |
| | count (≤16) | associative patch units |
| | | followed by consecutive |
| | | direct-mapped patch units) |
| 0x3 | Quantity of direct-mapped | Augmentation of other patch |
| (Type-3) | patch units (≤64) | unit streams (e.g., Type-1 or |
| | | Type-2) with larger informa- |
| | | tion blocks (e.g., consecutive |
| | | direct-mapped patch units and |
| | | excluding fully associative |
| | | units) |

In example implementations, the type 312 field of the descriptor patch unit 302 can be realized with the type (T) in the Table 1 above. Similarly, the count 314 field of the descriptor patch unit 302 can be realized with the count (C) in the Table 1 above. A descriptor patch unit 302 can, however, be realized in alternative manners. For some patch units, the count 314 field may include a first count part and a second count part. For instance, the count 314 field of the Type-2 patch unit can include a first count part and a second count part to indicate succeeding quantities of fully associative patch units 304 and direct-mapped patch units 306.

Generally, the use of these patch unit 352 data structures allows the system to avoid rigid, predefined ratios of patch types in the ROM patch 114. By extracting the fields for the type 312 and the count 314 from the descriptor patch unit 302, a patch controller enables the use of a ROM patch 114 that has dynamically allocated space between fully associative patch types and direct-mapped patch types. This arrangement facilitates efficient utilization of the non-volatile patch memory 112 by reducing the need for fixed partitions. Furthermore, the inclusion of a padding patch unit (e.g., a padding byte indicated by Type=0x0, Count=0x1) in the ROM patch protocol 116 allows the ROM patch 114 to satisfy error code alignment 210 obligations without wasting significant storage space. The end-of-stream marker 356 (e.g., Type=0x0, Count=0x0) additionally enables the hardware to terminate transmission of the ROM patch stream 118 “early,” which reduces the time the system spends in a reset mode and decreases overall boot-up latency.

FIG. 4 is a diagram 400 depicting example patch unit streams 354-1 to 354-5 that each include at least one descriptor patch unit 302 indicative of a patch type for 404 the patch unit stream 354 in accordance with a streaming protocol to support ROM patching. Each illustrated patch unit stream 354, such as any of the patch unit streams 354-1, 354-2, 354-3, 354-4, or 354-5, represents a different configuration or arrangement of information that can be transmitted in a ROM patch stream 118. These configurations demonstrate the flexibility of described streaming protocol implementations to accommodate varying patching requirements using a descriptor patch unit 302 to define a set 402 of succeeding patch units 304 or 306. In example implementations, for each patch unit stream 354, a descriptor patch unit 302 precedes a set 402 of one or more patch units 304 or 206 in the stream.

In a first example, the patch unit stream 354-1 is configured as a first patch type 404-1. The patch unit stream 354-1 includes a descriptor patch unit 302 followed by a set 402 of “N” fully associative patch units 304, where “N” is an integer. In this instance, the descriptor patch unit 302 includes a type 312 field indicative of fully associative patch units 304 (e.g., Type-1) and a count 314 field indicative of a quantity of “N”. A second example is illustrated by the patch unit stream 354-2, which is configured as a second patch type 404-2. The patch unit stream 354-2 includes a descriptor patch unit 302 followed by a set 402 that includes four fully associative patch units 304 and “N” direct-mapped patch units 306. Here, the descriptor patch unit 302 includes a type 312 field indicative of mixed patch unit types (e.g., Type-2) and a count 314 field that identifies the respective quantities of both patch unit types within the set 402. Thus, a first count part of the count 314 field can indicate four, and a second count part of the count 314 field can indicate “N.”

In a third example, the patch unit stream 354-3 illustrates how multiple descriptors can be chained within a single patch transaction. The patch unit stream 354-3 includes a first descriptor patch unit 302 followed by a set 402 of three fully associative patch units 304 (e.g., the first patch type 404-1). This is consecutively followed by a second descriptor patch unit 302 and a set 402 of “N” direct mapped patch units 306, which is configured as a third patch type 404-3. For this second portion of the patch transaction, the descriptor patch unit 302 includes a type 312 field indicative of direct-mapped patch units 306 (e.g., Type-3) and a count 314 field indicative of a quantity of “N.” This arrangement allows for the delivery of a large direct-mapped code block that follows an initial group of inline instruction replacements.

In a fourth example, the patch unit stream 354-4 illustrates a relatively complex configuration that combines a mixed-type patch portion with an augmenting patch portion. The patch unit stream 354-4 includes a descriptor patch unit 302 followed by two fully associative patch units 304 and two direct-mapped patch units 306 (e.g., for the second patch type 404-2). This is followed by another descriptor patch unit 302 and an additional set 402 of direct-mapped patch units 306 (e.g., for the third patch type 404-3). This shows another example of how the third patch type can be used in conjunction with the first or second patch type.

Further, the patch unit stream 354-5 is configured as a fourth patch type 404-0 (or a “zeroth” patch Type-0). The patch unit stream 354-5 includes a descriptor patch unit 302 that is not followed by any associated patch units. This zeroth patch type 404-0 can realize a control transaction, such as an end-of-stream marker 356 or at least one padding patch unit 406. In some cases, each padding-related descriptor patch unit 302 corresponds to a single padding patch unit 406, which may have the same size (e.g., length) as other descriptor patch units 302. In other cases, a padding-related descriptor patch unit 302 can explicitly indicate a size of the padding (e.g., a quantity of bytes or a size equal to a quantity of multiple descriptor patch units 302). The former case is simpler to implement but may require a longer transmission stream, while the latter case may shorten the transmission stream at the cost of control complexity.

These example configurations provide a patching environment with multiple technical advantages. By supporting various combinations of the first patch type 404-1, the second patch type 404-2, the third patch type 404-3, and the zeroth patch type 404-0, each ROM patch can be tailored to the specific needs of a bug fix or a feature update. This dynamic organization avoids the storage waste associated with fixed partitions while allowing for incremental patches to be added to the non-volatile patch memory 112 at different times. Additionally, the ability to “chain” descriptor patch units 302 as shown in example patch unit streams 354-3 and 354-4 ensures that large or complex code updates can be delivered efficiently without requiring a descriptor patch unit 302 to support excessively large count fields.

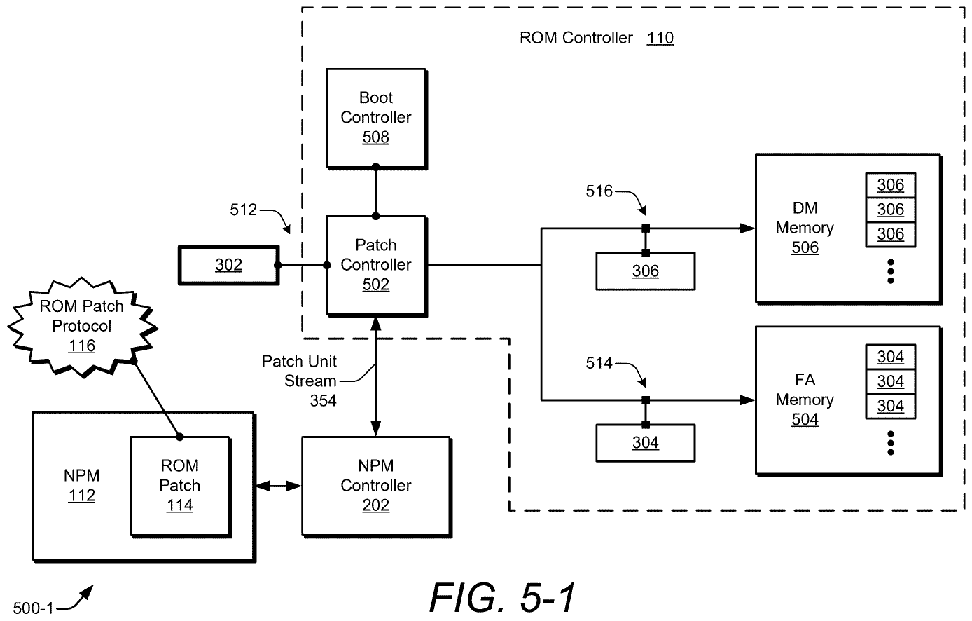

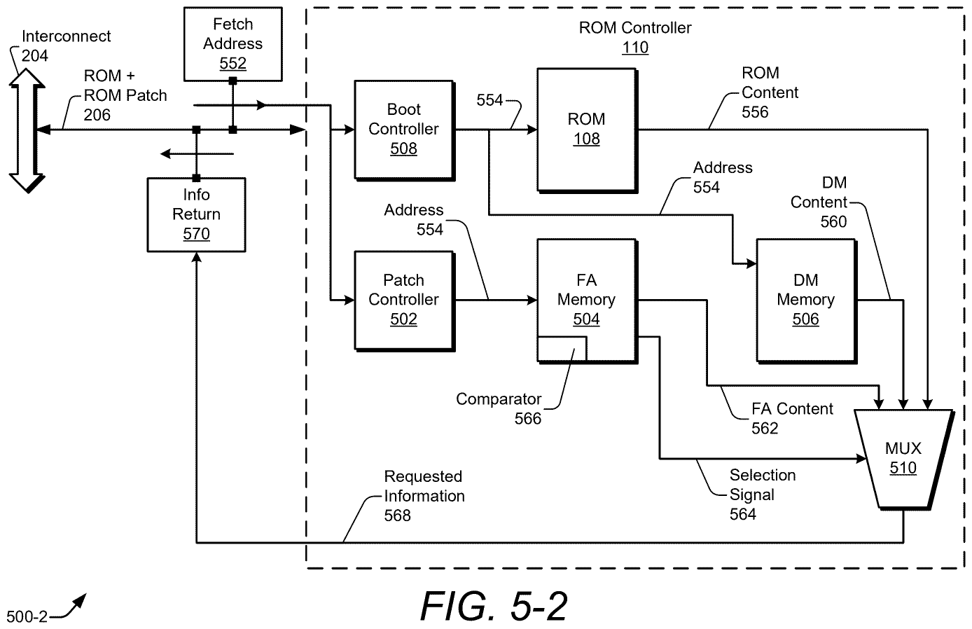

FIG. 5-1 is a schematic diagram 500-1 illustrating example techniques for loading a ROM patch 114 from a non-volatile patch memory 112 in accordance with a streaming ROM patch protocol 116 to support ROM patching. The schematic diagram 500-1 establishes an example structural baseline for how a ROM controller 110 can internalize ROM patch information during an initialization or boot-up process. As shown, the ROM controller 110 includes a patch controller 502, a fully associative memory 504 (FA memory 504), a direct-mapped memory 506 (DM memory 506), and a boot controller 508. Each of the memory structures, the fully associative memory 504 and the direct-mapped memory 506, is configured to store at least one specific type of ROM patch content received from the non-volatile patch memory 112.

In example implementations, the boot controller 508 is coupled to the patch controller 502. The boot controller 508 can coordinate the overall sequence of booting operations, including at least part of the ROM patching procedure. To facilitate the transfer of ROM patch information, the non-volatile patch memory controller 202 is coupled to the non-volatile patch memory 112 and the patch controller 502. The non-volatile patch memory controller 202 retrieves the ROM patch 114 from the non-volatile patch memory 112 and provides at least one patch unit stream 354, which forms part of a ROM patch stream 118, to the ROM controller 110. Within the ROM controller 110, the patch controller 502 establishes multiple processing (e.g., routing) paths to direct ROM patching information to the appropriate internal memory destination. For example, a descriptor-processing path 512 facilitates the parsing of metadata in the patch unit stream 354. Additionally, a fully associative routing path 514 and a direct-mapped routing path 516 facilitate the delivery of ROM patching information content to the designated memory destination. These components, routing paths, and signals (e.g., which may carry information organized into data structures as described herein) work together to transform a raw stream of bits into an organized set of hardware-accessible instructions and data.

In example operations, the patch controller 502 receives from the non-volatile patch memory controller 202 the patch unit stream 354 as a sequence of bits that are organized into multiple patch units 352. The patch controller 502 parses the stream of multiple patch units 352 to identify a descriptor patch unit 302 that provides header information, or patch-unit-stream metadata, to interpret the information that follows in a succeeding set of patch units. By parsing the descriptor patch unit 302, the patch controller 502 extracts at least one type 312 and at least one count 314. If the at least one type 312 indicates a fully associative patch type (e.g., a Type-1), the patch controller 502 routes the succeeding fully associative patch units 304 to the fully associative memory 504 via the fully associative routing path 514. On the other hand, if the at least one type 312 indicates a direct-mapped patch type (e.g., a Type-3), the patch controller 502 routes the succeeding direct-mapped patch units 306 to the direct-mapped memory 506 via the direct-mapped routing path 516. For a patch unit stream 354 having a mixed-type (e.g., Type-2), the patch controller 502 routes respective patch types (e.g., FA and DM) to associated respective memories of that corresponding respective patch type (e.g., FA and DM).

To manage the dynamic nature of the incoming information, the patch controller 502 can utilize a pointer mechanism to track a current position within the patch unit stream 354 and the overall ROM patch stream 118 (e.g., of FIG. 3-2). The patch controller 502 can initialize a pointer (not shown) at the beginning of the ROM patch stream 118 and advance the pointer based on metadata extracted from each descriptor patch unit 302. For instance, the patch controller 502 can calculate a quantity of a set of patch units that succeed the descriptor patch unit 302 based on the at least one count 314. The patch controller 502 then advances the pointer by that quantity to locate a next subsequent descriptor patch unit 302. The patch controller 502 can also use the counter in conjunction with first and second count parts of the at least one count 314 to differentiate between fully associative patch units 304 and direct-mapped patch units 306 in a Type-2 patch stream unit 354, like the patch stream units 354-2 and 354-4 of FIG. 4. The pointer may keep track of a location along the ROM patch stream 118 in terms of patch units 352, in terms of an underlying data-processing size for the device (e.g., a byte or word), some combination thereof, and so forth.

This pointer-based logic also allows the patch controller 502 to virtually skip over at least one control-related patch unit, such as a padding patch unit 406. The patch controller 502 can therefore accommodate portions of the ROM patch stream 118 that do not include ROM patch contents. This capability enables the ROM patch 114 to have incremental patch boundaries that comport with an error code alignment 210 to facilitate adding error codes 208 (e.g., both of FIG. 2) gradually during a manufacturing process instead of at the end of the manufacturing process. By utilizing pointers in this manner, the patch controller 502 can seamlessly process a continuous stream of contiguous varying ROM patch types without requiring fixed memory offsets or rigid partitions.

Additionally, in some implementations, the streaming protocol for ROM patching supports multiple techniques for the early termination of a ROM patch transfer based on an end-of-stream marker 356. Thus, the inclusion of an end-of-stream marker 356 in the ROM patch stream 118 enables the early termination of the streaming process upon detection thereof. This reduction in data transfer size directly minimizes the time the system spends in a reset mode, thereby decreasing boot-up latency for the electronic device. In some cases, the patch controller 502 parses metadata from the patch unit stream 354 and, upon detecting the end-of-stream marker 356, sends a cease transmission signal to the non-volatile patch memory controller 202. This active signaling allows the patch controller 502 to maintain control over the transaction state and ensures that no further data is driven onto the bus once the valid patches are received and the non-volatile patch memory controller 202 receives the command to cease transmission. In other cases, the non-volatile patch memory controller 202 may be configured to be data-structure aware. If so, the non-volatile patch memory controller 202 can detect the end-of-stream marker 356 within the ROM patch 114 and cease transmitting on its own accord. In either case, the reduction in unnecessary data transfer reduces the time consumed to initialize the electronic device.

The component arrangements and operations illustrated in FIG. 5-1 provide technical advantages over other ROM patching architectures. By using the descriptor-driven routing logic, the patch controller 502 can account for how the allocation of the fully associative patch units 304 and the direct-mapped patch units 306 were made previously at each incremental ROM update during manufacturing and by properly routing them to the fully associative memory 504 and the direct-mapped memory 506, respectively, during boot time. This flexibility avoids the waste of expensive one-time programmable (OTP) memory resources and allows for ROM patches to be interleaved as needed.

FIG. 5-2 is a schematic diagram 500-2 illustrating example techniques for providing ROM content 556 and ROM patch content (560 or 562) to a processor 106 during boot time in accordance with a streaming protocol to support ROM patching. The diagram 500-2 illustrates the functional interaction between the components of the ROM controller 110 after a ROM patch 114 has been assimilated into the local memory structures. In example implementations, the ROM controller 110 includes the boot controller 508 and the patch controller 502, which jointly manage access to the ROM 108, the fully associative memory 504, and the direct-mapped memory 506. The interconnect 204 is coupled to the ROM controller 110 to facilitate the exchange of information with the processor 106 (e.g., of FIG. 2). A multiplexer 510 (MUX 510) is also included within the ROM controller 110 to select the appropriate information to return to the processor 106.

In example operations, the ROM controller 110 receives a fetch address 552 command from the processor 106 via the interconnect 204. The fetch address 552 command includes an address of an instruction or data value that the processor 106 is attempting to retrieve as part of the boot-up process. The ROM controller 110 distributes this address to multiple internal destinations simultaneously or in a coordinated sequence. For instance, the address to be fetched can be provided by the boot controller 508 as an address 554 to the ROM 108. Responsive to the address 554, the ROM 108 produces ROM content 556, which corresponds to the original, unpatched code stored in the ROM 108 in association with the address 554. The ROM 108 provides the ROM content 556 to an input of the multiplexer 510.

The address 554 identified by the fetch address 552 command is also provided to the patch controller 502 for a determination of whether a corresponding patch exists. Within the patch controller 502, the address 554 is applied to a comparator 566. The comparator 566 is configured to compare the incoming address 554 to target addresses stored in the fully associative memory 504. If the comparator 566 identifies a match, the patch controller 502 generates a selection signal 564 indicative of a match. Responsive to a match, the fully associative memory 504 provides fully associative content 562 (FA content 562) to another input of the multiplexer 510.

The circuitry depicted in FIG. 5-2 can be arranged or organized differently. For example, the fully associative memory 504 or the direct-mapped memory 506 can be logically or physically part of the patch controller 502. The circuitry can also operate in alternative manners. For example, the fully associative memory 504 can determine if a corresponding ROM patch exists for the address 554. For instance, the fully associative memory 504 can be realized as a content-addressable memory (CAM) that performs one or more comparisons using one or more comparators 566 of the address 554 to one or more stored target addresses.

In some instances, the fully associative content 562 includes a replacement instruction that is intended to be executed instead of the original ROM content 556. In other instances, the fully associative content 562 includes a jump instruction that contains an address that redirects patched ROM execution to the direct-mapped memory 506 (e.g., a direct-mapped address that is within the address range of the direct-mapped memory 506). In each case, the ROM controller 110 returns to the processor 106 the fully associative content 562, which includes an instruction for execution by the processor 106. If this instruction is a jump instruction that contains a direct-mapped address, the next request from the processor 106 is another fetch address 552 command, with this other fetch address 552 corresponding to an address targeting the address range of the direct-mapped memory 506 from the redirecting jump instruction. Thus, the address 554 may target a memory location of the direct-mapped memory 506 in at least such instances. In response, the direct-mapped memory 506 outputs direct-mapped content 560 from the targeted address to another input of the multiplexer 510 for forwarding to the processor 106.

Thus, the ROM content 556, the direct-mapped content 560, and the fully associative content 562 are all provided as inputs to the multiplexer 510. The multiplexer 510 also includes at least one control input that receives the selection signal 564, which may be formed from one or more bits. The multiplexer 510 utilizes the selection signal 564 to select between at least the fully associative content 562 and other content, like the original ROM content 556 or the direct-mapped content 560 to produce requested information 568. Additionally or alternatively, other circuitry (e.g., an address decoder (not shown) of the boot controller 508) of the ROM controller 110 can differentiate between an address 554 that maps to the ROM 108 or to the direct-mapped memory 506 to determine what content is forwarded from the at least one multiplexer 510. The multiplexer 510 provides the requested information 568 at an output thereof based at least on the selection signal 564. The ROM controller 110 (e.g., the boot controller 508 thereof) then provides the requested information 568 to the processor 106 as an information return 570 communication via the interconnect 204.

The runtime processes and signaling illustrated in FIG. 5-2 provide several technical advantages for the electronic device 102. By utilizing the comparator 566 and the multiplexer 510, the ROM controller 110 can perform real-time ROM-information replacement without requiring any modifications to the physical ROM 108. The use of a selection signal 564 derived from the fully associative memory 504 ensures that the processor 106 can seamlessly transition between original ROM code and patched ROM code with lower timing overhead. Furthermore, the ability to redirect the processor 106 to the direct-mapped memory 506 via a jump instruction stored in the fully associative memory 504 enables the application of complex, multi-instruction fixes that exceed the storage capacity of a single fully associative entry. This architectural synergy enables the electronic device 102 to execute a corrected instruction flow that effectively utilizes combined ROM and ROM patch 206 content.

Having generally described schemes, techniques, and hardware for implementing a streaming protocol to support ROM patching, this discussion now turns to example methods.

### Example Methods

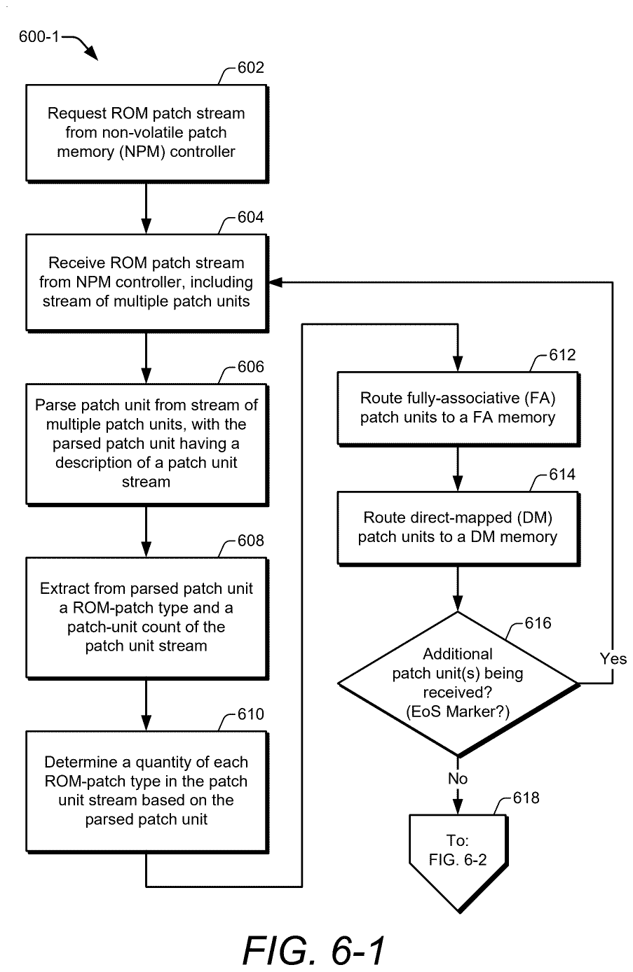

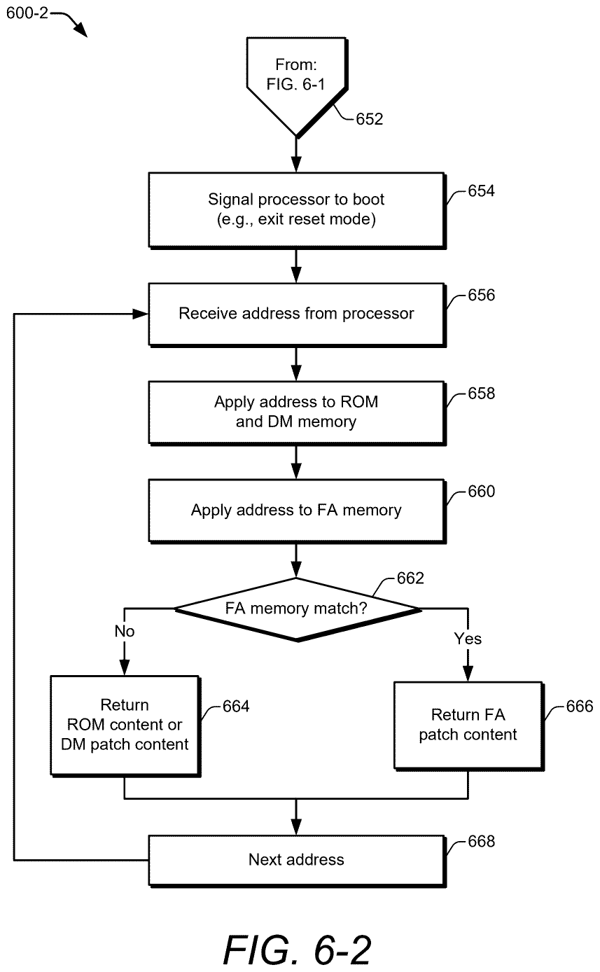

FIG. 6-1 is a flow chart 600-1 illustrating example techniques for loading a ROM patch from a non-volatile patch memory in accordance with a streaming protocol to support ROM patching. The flow chart 600-1 includes nine (9) blocks 602 to 618. In example implementations, the operations of the flow chart 600-1 may be performed by an SoC 104, such as a ROM controller 110 thereof. More specifically, the operations of the flow chart 600-1 may be performed by a patch controller 502 of the ROM controller 110. Generally, FIG. 6-1 is a flow chart illustrating example processes 600-1 for loading and routing patch units 352 from a non-volatile patch memory 112 in accordance with a streaming protocol.

At 602, the patch controller 502 requests a ROM patch stream 118 from a non-volatile patch memory controller 202. The request can be triggered by a boot controller 508 during a transition from a reset mode to an active boot mode. At 604, the patch controller 502 receives the ROM patch stream 118 from the non-volatile patch memory controller 202. The received stream includes a sequence of multiple patch units 352 that carry stream metadata or ROM information.

At 606, the patch controller 502 parses a patch unit 352 from the ROM patch stream 118. This parsed patch unit 352 acts as a descriptor patch unit 302 that provides a description of a set 402 of patch units 352 that follow the descriptor patch unit 302 in a patch unit stream 354. At 608, the patch controller 502 extracts from the parsed patch unit 352 at least one ROM-patch type 312 and at least one patch-unit count 314. These fields identify the nature and the quantity of the information-carrying patch units 352 that are expected to follow in the ROM patch stream 118.

At 610, the patch controller 502 determines a quantity of each ROM-patch type in the patch unit stream 354 based on the metadata in the parsed patch unit 352 (e.g., the descriptor patch unit 302). For example, for a mixed-patch-type 404-2 patch unit stream 354-2 or 354-4, the patch controller 502 identifies a first quantity for fully associative patch units 304 and a second quantity for direct-mapped patch units 306. These quantities can guide the incrementing of the pointer used by the patch controller 502 to track progress along the overall ROM patch stream 118 for a current patch unit stream 354.

At 612, the patch controller 502 routes fully associative patch units 304 to a fully associative memory 504. The patch controller 502 can direct these units to specific slots or addresses within a CAM structure based on the extracted count and a current pointer value. At 614, the patch controller 502 routes direct-mapped patch units 306 to a direct-mapped memory 506. These units may be stored in an SRAM structure to provide additional code or data regions for the ROM that is executed by the processor 106.

At 616, the patch controller 502 determines if additional patch units 352 are being received from the non-volatile patch memory controller 202 or if an end-of-stream marker 356 is detected. If more patch units 352 are expected, the process 600-1 returns to operation 604 to continue receiving and parsing patch units 352 in the ROM patch stream 118. Otherwise, responsive to a detected end-of-stream marker 356, the ROM-patch loading process can terminate. At 618, the patch controller 502 or the boot controller 508 proceeds to the runtime operations illustrated in FIG. 6-2. This transition marks the completion of the ROM patch assimilation and the beginning of the processor receiving ROM information for the booting process.

FIG. 6-2 is a flow chart 600-2 illustrating example techniques for providing ROM content and ROM patch content to a processor during boot time in accordance with a streaming protocol to support ROM patching. The flow chart 600-2 includes nine (9) blocks 652 to 668. In example implementations, the operations of the flow chart 600-1 may be performed by an SoC 104, such as a ROM controller 110 thereof. More specifically, the operations of the flow chart 600-2 may be performed by a boot controller 508 or a patch controller 502 of the ROM controller 110.

Generally, FIG. 6-2 is a flow chart illustrating example processes 600-2 for retrieving and applying patched information during a boot sequence of a processor. At operation 652, the booting or reset process transitions from the ROM-patch loading sequence described in FIG. 6-1. This transition can occur after the hardware ROM-patching memory structures have been populated with the relevant ROM patch content.

At 654, the boot controller 508 signals the processor 106 to boot. For example, the boot controller 508 may release a reset signal to allow the processor 106 to begin fetching information (e.g., instructions) from the ROM controller 110. At 656, the ROM controller 110 (e.g., the boot controller 508 or the patch controller 502) receives a fetch address 552 command from the processor 106. This command can be received via a system interconnect 204.

At 658, the boot controller 508 or other circuitry of the ROM controller 110 applies the address-to-be-fetched to the ROM 108 or the direct-mapped memory 506 as the address 554. The ROM 108 can then produce the “original” ROM content 556 corresponding to the requested address, or the direct-mapped memory 506 can produce the direct-mapped content 560 corresponding to the requested address. At 660, the patch controller 502 applies the address-to-be-fetched to a fully associative memory 504 as the address 554. The at least one comparator 566, which may be part of the fully associative memory 504, can perform a lookup or multiple comparison operations to identify whether a ROM patch exists for the specific address.

At 662, the patch controller 502 or the fully associative memory 504 determines if a match is found in the fully associative memory 504. A match can result in the generation of a selection signal 564 to control, at least partly, the selection or routing of ROM information to the processor 106. At operation 664, if no match is found at 662, the ROM controller 110 returns to the processor 106 the ROM content 556 that is retrieved from the ROM 108 or the direct-mapped content 560 that is retrieved from the direct-mapped memory 506. This operation may be facilitated by the multiplexer 510 selecting the output of the ROM 108 or the output of the direct-mapped memory 506, respectively, based on the address range of each.

On the other hand, a match to an address in the fully associative memory 504 may be detected (the “yes” branch from 662). At operation 666, if a match is found at 662, then the ROM controller 110 returns to the processor 106 the fully associative patch content 562. The returned fully associative patch content 562 can include a replacement instruction or a branch instruction. At operation 668, another address for the ROM can be processed. To do so, the flow chart 600-2 can loop back to the operation 656 to receive another address 554 from the processor 106 to facilitate the continuous execution of a patched (e.g., corrected or updated) ROM instruction flow. If the fully associative patch content 562 is a branch instruction, the next cycle includes an address that is within the address range of the direct-mapped memory 506, and the operations 658 and 664 will pertain to retrieving additional direct-mapped content 560 from the direct-mapped memory 506.

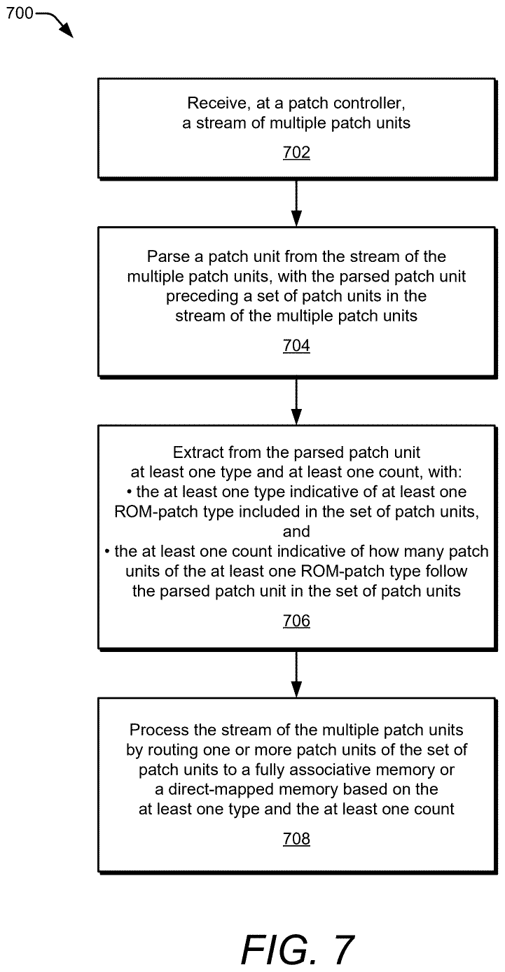

FIG. 7 is a flow diagram 700 illustrating example processes for supporting ROM patching using a streaming protocol. The flow diagram 700 includes four (4) blocks 702-708. In example implementations, the operations of the flow diagram 700 may be performed by an SoC 104, such as a ROM controller 110 thereof. Further, the ROM controller 110 can include a patch controller 502.

At block 702, a stream of multiple patch units is received at a patch controller. For example, the patch controller 502 can receive a ROM patch stream 118 including multiple patch units 352. To do so, the patch controller 502 may communicate with a non-volatile patch memory controller 202 to initiate a data transfer from a non-volatile patch memory 112. This may occur during an initialization phase while a processor 106 is maintained in a reset mode. Thus, this operation enables the system to acquire ROM patch information without requiring the processor 106 to manage the retrieval process.

At block 704, a patch unit is parsed from the stream of the multiple patch units, with the parsed patch unit preceding a set of patch units in the stream of the multiple patch units. For example, the patch controller 502 can parse a patch unit 352 from the ROM patch stream 118, where the parsed patch unit 352 precedes a set 402 of patch units 352 in the stream 118 of the multiple patch units. In some cases, the patch controller 502 may identify the parsed patch unit 352 as a descriptor patch unit 302 that acts as a header for the set 402 of patch units 352 that together form a patch unit stream 354. For instance, the patch controller 502 may utilize a pointer mechanism to distinguish the descriptor patch unit 302 from following (and preceding) ROM-information-carrying patch units 352. This parsing logic allows the hardware to navigate a continuous stream of contiguous and varying ROM-patch types by identifying demarcations between metadata and ROM information (e.g., ROM instructions or ROM data).

At block 706, at least one type and at least one count are extracted from the parsed patch unit. The at least one type is indicative of at least one ROM-patch type that is included in the set of patch units, and the at least one count is indicative of how many patch units of the at least one ROM-patch type follow the parsed patch unit in the set of patch units. For example, the patch controller 502 can extract from the parsed descriptor patch unit 302 at least one type 312 and at least one count 314. To do so, the patch controller 502 may identify specific bit-fields within a given block of information (e.g., within a single byte), like a two-bit ROM-type field and a six-bit count field for a quantity of related patch units 352.

In some cases, the patch controller 502 may determine, based on the at least one type 312, whether the set 402 of patch units that follow the descriptor patch unit 302 includes one or more fully associative patch units 304, one or more direct-mapped patch units 306, or a combination of both at least one fully associative patch unit 304 and at least one direct-mapped patch unit 306. Additionally, the patch controller 502 may determine, based on the at least one count 314, a quantity of patch units 352 of each ROM-patch type that are in the set 402 of patch units following the descriptor patch unit 302. This field extraction and descriptor processing enables the patch controller 502 to be data-structure aware. Thus, the hardware can adapt its internal routing logic based on streamed metadata rather than being limited to a fixed memory partition scheme.

At block 708, the stream of the multiple patch units is processed by routing one or more patch units of the set of patch units to a fully associative memory or a direct-mapped memory based on the at least one type and the at least one count. For example, the patch controller 502 can process the ROM patch stream 118 with the multiple patch units 352 by routing one or more patch units 352 of the set 402 to a fully associative memory 504 or a direct-mapped memory 506 based on the at least one type 312 and the at least one count 314. To do so, the patch controller 502 may direct fully associative patch units 304 to a fully associative memory 504 (e.g., a content-addressable memory) and direct-mapped patch units 306 to a direct-mapped memory 506 (e.g., a static random-access memory). Thus, the patch controller 502 may utilize the at least one count 314 to calculate a total size of the set 402 and advance a pointer past the set 402 to locate a subsequent descriptor patch unit 302. This dynamic routing provides the benefit of optimizing the utilization of expensive non-volatile memory resources by allowing different ROM-patch types to be interleaved and sized according to the needs of each specific ROM update.

Aspects of these methods may be implemented in, for example, hardware (e.g., fixed logic circuitry, a controller, a finite state machine, or a processor in conjunction with a memory), firmware, software, or some combination thereof. The methods may be realized to produce one or more of the apparatuses or components shown in FIGS. 1 to 5-2 and 8, which components may be further divided, combined, and so on. The devices and components of these figures generally represent hardware, such as electronic devices, PCBs, packaged modules, IC chips, components, or circuits; firmware; software; or a combination thereof. Thus, these figures illustrate some of the many possible systems or apparatuses capable of being produced using the described methods.

For the methods described herein and the associated flow chart(s) and/or flow diagram(s), the orders in which operations are shown and/or described are not intended to be construed as a limitation. Instead, any number or combination of the described method operations can be combined in any order to implement a given method or an alternative method, including by combining operations from different ones of the flow chart(s) and flow diagram(s) and the earlier-described schemes and techniques into one or more methods. Operations may also be omitted from or added to the described methods. Further, described operations can be implemented in fully or partially overlapping manners.

### Additional Example Apparatuses and Electronic Devices

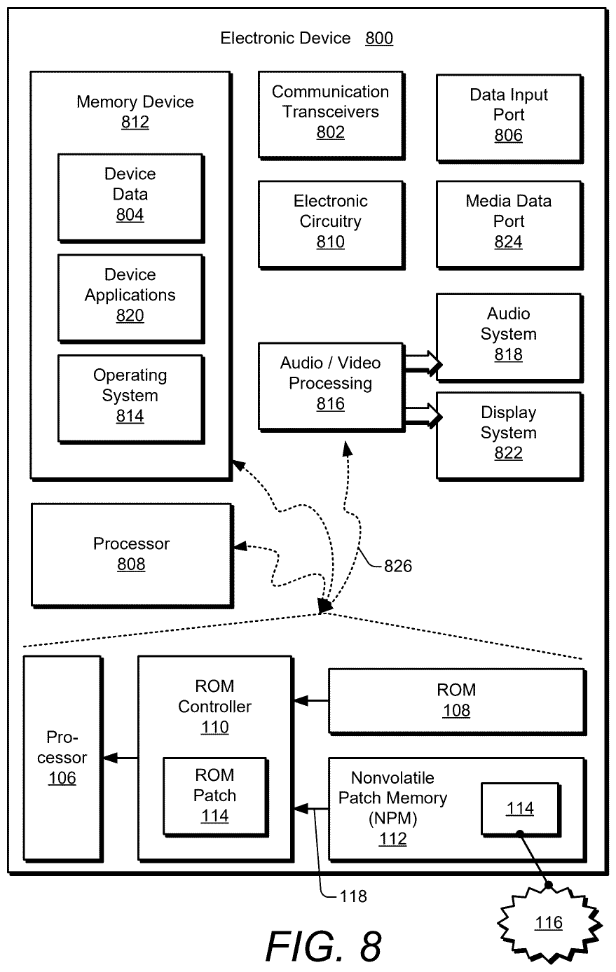

FIG. 8 illustrates various components of an example electronic device 800 that can implement a streaming protocol to support ROM patching in accordance with one or more described aspects. The electronic device 800 may be implemented as any one or combination of a fixed, mobile, stand-alone, or embedded device or in any form of a consumer, computer, portable, user, server, communication, phone, navigation, gaming, audio, camera, messaging, media playback, and/or other type of electronic device 800, such as the smartphone that is depicted in FIG. 1 as the apparatus 102. One or more of the illustrated components may be realized as discrete components or as integrated components on at least one integrated circuit of the electronic device 800 or separately or jointly in one or more packages of the electronic device 800.

The electronic device 800 can include one or more communication transceivers 802 that enable wired and/or wireless communication of device data 804, such as received data, transmitted data, or other information identified above. Example communication transceivers 802 include near-field communication (NFC) transceivers, wireless personal area network (PAN) (WPAN) radios compliant with various IEEE 802.15 (Bluetooth®) standards, wireless local area network (LAN) (WLAN) radios compliant with any of the various IEEE 802.11 (Wi-Fi®) standards, wireless wide area network (WAN) (WWAN) radios (e.g., those that are 3GPP-compliant) for cellular telephony, wireless metropolitan area network (MAN) (WMAN) radios compliant with various IEEE 802.16 (WiMAX™) standards, infrared (IR) transceivers compliant with an Infrared Data Association (IrDA) protocol, and wired local area network (LAN) Ethernet transceivers.

The electronic device 800 may also include one or more data input ports 806 via which any type of data, media content, and/or other inputs can be received, such as user-selectable inputs, messages, applications, music, television content, recorded video content, and any other type of audio, video, and/or image data received from any content and/or data source, including a sensor like a microphone or a camera. The data input ports 806 may include USB ports, coaxial cable ports, fiber optic ports for optical fiber interconnects or cabling, and other serial or parallel connectors (including internal connectors) for flash memory, DVDs, CDs, and the like. These data input ports 806 may be used to couple the electronic device to components, peripherals, or accessories such as keyboards, microphones, cameras, or other sensors.

The electronic device 800 of this example includes at least one processor 808 (e.g., any one or more of application processors, microprocessors, digital-signal processors (DSPs), controllers, and the like), which can include a combined processor and memory system (e.g., implemented as part of an SoC), that processes (e.g., executes) computer-executable instructions to control operation of the device. The processor 808 may be implemented as an application processor, embedded controller, microcontroller, security processor, artificial intelligence (AI) accelerator, and the like. Generally, a processor or processing system may be implemented at least partially in hardware, which can include components of an integrated circuit or on-chip system, a digital signal processor (DSP), an application-specific integrated circuit (ASIC), a field programmable gate array (FPGA), a complex programmable logic device (CPLD), and other implementations in silicon and/or other materials.

Alternatively or additionally, the electronic device 800 can be implemented with any one or combination of electronic circuitry, which may include software, hardware, firmware, or fixed logic circuitry that is implemented in connection with processing and control circuits, which are generally indicated at 810 (as electronic circuitry 810). This electronic circuitry 810 can implement executable or hardware-based modules (not shown in FIG. 8), such as through processing/computer-executable instructions stored on computer-readable media, through logic circuitry and/or hardware (e.g., such as an FPGA), and so forth.

The electronic device 800 can include a system bus, interconnect, crossbar, data transfer system, switch fabric, or other communication fabric that couples the various components within the device. A system bus or interconnect can include any one or a combination of different bus structures, such as a memory bus or memory controller, a peripheral bus, a universal serial bus (USB), and/or a processor or local bus that utilizes any of a variety of bus architectures.

The electronic device 800 also includes one or more memory devices 812 that enable data storage, examples of which include random-access memory (RAM), non-volatile memory (e.g., read-only memory (ROM), flash memory, EPROM, and EEPROM), and a disk storage device. Thus, the memory device(s) 812 can be distributed across different logical storage levels of a system as well as at different physical components. The memory device(s) 812 provide data storage mechanisms to store the device data 804, other types of code and/or data, and various device applications 820 (e.g., software applications or programs). For example, an operating system 814 can be maintained as software instructions within the memory device 812 and executed by the processor 808.

In some implementations, the electronic device 800 also includes an audio and/or video processing system 816 that processes audio and/or video data and/or that passes through the audio and/or video data to an audio system 818 and/or to a display system 822 (e.g., a video buffer or a screen of a smartphone or camera). The audio system 818 and/or the display system 822 may include any devices that process, display, and/or otherwise render audio, video, display, and/or image data. Display data and audio signals can be communicated to an audio component and/or to a display component via an RF (radio-frequency) link, an S-video link, an HDMI (high-definition multimedia interface) link, a composite video link, a component video link, a DVI (digital video interface) link, an analog audio connection, a video bus, or another similar communication link, such as a media data port 824. In some implementations, the audio system 818 and/or the display system 822 are external or separate components of the electronic device 800. Alternatively, the display system 822, for example, can be an integrated component of the example electronic device 800, such as part of an integrated touch interface.

The electronic device 800 of FIG. 8 illustrates example implementations of the apparatus 102 of FIG. 1, of an apparatus that includes a ROM controller 110 and a non-volatile patch memory 112 storing a ROM patch 114 to enable support for ROM patching using a ROM patch protocol 116 as with any of the FIGS. 2 to 7, or some combination thereof. Accordingly, one of the components illustrated in FIG. 8 and discussed above may realize or incorporate at least part of the other components described herein. These other components can include the processor 106, the ROM controller 110, the ROM 108, and the non-volatile patch memory 112. For example, as indicated by the arrows 826, the processor 808 may realize the processor 106. The memory device 812 may realize the ROM 108 and the non-volatile patch memory 112. Further, the electronic circuitry 810 may realize the ROM controller 110.

As illustrated in the lower portion of FIG. 8, the electronic device 800 incorporates the ROM-patching architecture depicted in FIGS. 1 through 7 and described herein. The processor 808 is coupled to the ROM controller 110, which manages access to the ROM 108 and the non-volatile patch memory 112. The non-volatile patch memory 112 stores the ROM patch 114 that is organized in accordance with a ROM patch protocol 116. During a boot sequence, the electronic circuitry 810 can coordinate the transfer of the ROM patch stream 118 from the non-volatile patch memory 112 to the ROM controller 110.

This system-level arrangement ensures that the processor 808 receives a patched instruction flow (e.g., a combination of ROM content and ROM patch content) upon exiting a reset mode. By utilizing the descriptor-driven streaming protocol, the electronic device 800 enhances the utilization of the non-volatile patch memory 112 and reduces the time required for initialization. Specifically, the electronic circuitry 810 can identify an end-of-stream marker 356 within the ROM patch stream 118 and signal the processor 808 to begin fetching ROM information from the ROM controller 110 as soon as all valid patches are internalized. This integration allows the electronic device 800 to maintain a high security posture by using patched ROM information while reducing the impact on boot-up latency and storage overhead.

The terms “first,” “second,” “third,” and other numeric-related indicators are used herein to identify or distinguish similar or analogous items from one another within a given context-like a particular implementation, a single drawing figure, or a claim. However, this numbering terminology may differ from context to context or from implementation to implementation. Thus, a first item in one context may differ from a first item in another context. For example, a patch aspect (e.g., a patch unit or a patch unit stream) that is identified as a “first ROM-patch type” in one context may be identified as a “third ROM-patch type” in another context.

Features described in the context of one example aspect (e.g., a method or an apparatus) may be used in combination with other example aspects (e.g., an apparatus or a method, respectively, or a different method or a different apparatus).

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, c-c-c, and a-b-b-c, or any other ordering or quantity of a, b, and c). Further, items represented in the accompanying figures and terms discussed herein may be indicative of one or more items or terms, and thus reference may be made interchangeably to single or plural forms of the items and terms in this written description.

Although implementations for realizing a streaming protocol to support ROM patching have been described in language specific to certain features and/or methods, the subject of the appended claims is not necessarily limited to the specific features or methods described. Rather, the specific features and methods are disclosed as example implementations for supporting ROM patching using a streaming protocol.

What is claimed is:

1. An apparatus for supporting read-only memory (ROM) patching, the apparatus comprising:
a fully associative memory;
a direct-mapped memory; and
a patch controller coupled to the fully associative memory and the direct-mapped memory, the patch controller configured to:
receive a stream of multiple patch units;
parse a patch unit from the stream of the multiple patch units, the parsed patch unit preceding a set of patch units in the stream of the multiple patch units;
extract from the parsed patch unit at least one type and at least one count, the at least one type indicative of at least one ROM-patch type included in the set of patch units, the at least one count indicative of how many patch units of the at least one ROM-patch type follow the parsed patch unit in the set of patch units; and
process the stream of the multiple patch units by routing one or more patch units of the set of patch units to the fully associative memory or the direct-mapped memory based on the at least one type and the at least one count.

2. The apparatus of claim, wherein:
the parsed patch unit comprises a first descriptor patch unit of the stream of the multiple patch units; and
the patch controller is configured to:
identify a second descriptor patch unit in the stream of the multiple patch units based on the at least one count extracted from the first descriptor patch unit; and
continue processing the stream of the multiple patch units based on the second descriptor patch unit.

3. The apparatus of claim, wherein:
the patch controller is configured to identify multiple descriptor patch units in the stream of the multiple patch units based on multiple counts extracted from multiple previous descriptor patch units in the stream of the multiple patch units; and
each respective previous descriptor patch unit of the multiple previous descriptor patch units comprises at least one respective type and at least one respective count configured to indicate characteristics corresponding to succeeding patch units in the stream of the multiple patch units.

4. The apparatus of claim, wherein the patch controller is configured to:
parse a second patch unit from the stream of the multiple patch units;
extract from the parsed second patch unit a control indicator; and
process the parsed second patch unit based on the control indicator.

5. The apparatus of claim, wherein:
the control indicator comprises an end-of-stream marker; and
the patch controller is configured to cease processing the stream of the multiple patch units based on the end-of-stream marker.

6. The apparatus of claim, wherein the patch controller is configured to:
signal a non-volatile patch memory controller to terminate transmission of the stream of the multiple patch units based on the end-of-stream marker.

7. The apparatus of claim, wherein:
the apparatus further comprises a boot controller coupled to the patch controller; and
the boot controller is configured to signal a processor to start booting using read-only-memory instructions based on the end-of-stream marker.

8. The apparatus of claim, wherein:
the control indicator comprises a padding patch unit; and
the patch controller is configured to:
skip at least the padding patch unit; and
continue processing the stream of the multiple patch units based on the padding patch unit.

9. The apparatus of claim, wherein:
the padding patch unit comprises a single byte; and
the patch controller is configured to skip the padding patch unit and parse a third patch unit that immediately follows the second patch unit along the stream of the multiple patch units.

10. The apparatus of claim, wherein:
the apparatus comprises a non-volatile patch memory storing a read-only memory patch, the read-only memory patch comprising patch information corresponding to the stream of the multiple patch units; and
the read-only memory patch comprises an error code corresponding to multiple bytes of the patch information, the multiple bytes of the patch information including the single byte of the padding patch unit.

11. The apparatus of claim, further comprising:
a non-volatile patch memory storing a read-only memory patch, the read-only memory patch comprising the multiple patch units; and
a non-volatile patch memory controller coupled to the non-volatile patch memory and the patch controller, the non-volatile patch memory controller configured to provide the read-only memory patch from the non-volatile patch memory to the patch controller,
wherein the patch controller is configured to receive the stream of the multiple patch units from the non-volatile patch memory via the non-volatile patch memory controller.

12. The apparatus of claim, wherein:
the non-volatile patch memory comprises one-time programmable (OTP) memory.

13. The apparatus of claim, wherein:
the one-time programmable (OTP) memory comprises multiple fuses.

14. The apparatus of claim, wherein:
the read-only memory patch comprises multiple error codes respectively corresponding to multiple portions of the read-only memory patch;
an error code of the multiple error codes corresponds to a portion of the multiple portions;
the portion of the multiple portions includes at least one padding patch unit; and
the error code is based on the at least one padding patch unit and a remainder of the portion of the multiple portions.

15. The apparatus of claim, wherein:
the parsed patch unit comprises a descriptor patch unit configured to provide a header for the set of patch units that follow the descriptor patch unit in the stream of the multiple patch units.

16. The apparatus of claim, wherein the at least one ROM-patch type comprises at least one of:
a first ROM-patch type that includes one or more fully associative patch units and excludes direct-mapped patch units;
a second ROM-patch type that includes one or more fully associative patch units and one or more direct-mapped patch units; or
a third ROM-patch type that includes one or more direct-mapped patch units and excludes one or more fully associative patch units.

17. The apparatus of claim, wherein:
the at least one ROM-patch type comprises a first ROM-patch type that includes one or more fully associative patch units and excludes direct-mapped patch units; and
the at least one count is indicative of a quantity of the one or more fully associative patch units that are in the set of patch units that follow the descriptor patch unit.

18. The apparatus of claim, wherein:
the at least one ROM-patch type comprises a second ROM-patch type that includes one or more fully associative patch units and one or more direct-mapped patch units;
the at least one count comprises a first count part and a second count part;
the first count part is indicative of a quantity of the one or more fully associative patch units in the set of patch units that follow the descriptor patch unit; and
the second count part is indicative of a quantity of the one or more direct-mapped patch units in the set of patch units that follow the descriptor patch unit.

19. The apparatus of claim, wherein:
the at least one ROM-patch type comprises a third ROM-patch type that includes one or more direct-mapped patch units and excludes one or more fully associative patch units; and
the at least one count is indicative of a quantity of the one or more direct-mapped patch units that are in the set of patch units that follow the descriptor patch unit.

20. A method for supporting read-only memory (ROM) patching, the method comprising:
receiving, at a patch controller, a stream of multiple patch units;
parsing a patch unit from the stream of the multiple patch units, the parsed patch unit preceding a set of patch units in the stream of the multiple patch units;
extracting from the parsed patch unit at least one type and at least one count, the at least one type indicative of at least one ROM-patch type included in the set of patch units, the at least one count indicative of how many patch units of the at least one ROM-patch type follow the parsed patch unit in the set of patch units; and
processing the stream of the multiple patch units by routing one or more patch units of the set of patch units to a fully associative memory or a direct-mapped memory based on the at least one type and the at least one count.
